(19) United States
(12) Patent Application Publication
(10) Pub. No.: US 2025/0036002 A1
(43) Pub. Date: Jan. 30, 2025

(54) OPTICAL MODULE AND OPTICAL DISPLAY APPARATUS

(71) Applicants: INTERFACE TECHNOLOGY (CHENGDU) CO., LTD., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: Kun-Chih Hung, New Taipei (TW); Ting-Hui Chen, New Taipei (TW); Po-Lun Chen, Zhunan (TW); Yun-Pei Chen, New Taipei (TW)

(21) Appl. No.: 18/504,558

(22) Filed: Nov. 8, 2023

(30) Foreign Application Priority Data
Jul. 24, 2023 (CN) 202310914304.8

(51) Int. Cl. G02F 1/29

(52) U.S. Cl. CPC G02F 1/294

(57) ABSTRACT

An optical module includes a quarter wave plate, a first polarization converter, a second polarization, a lens assembly and a polarization reflection film. The quarter wave plate converts a polarization state of image light received. The first polarization converter and the second polarization converter receive the image light from the quarter-wave plate and focus the image light to a target position. The lens assembly includes a liquid crystal lens with a flat surface and a curved surface. The curved surface protrudes towards the quarter wave plate to make the liquid crystal lens to deflect the image light. The polarization reflection film receives the image light from the second polarization converter. The polarization reflection film is configured to transmit the image light having a target polarization state. The image light from the polarization reflection film converges at the target position to display an image.

### FIELD

The subject matter herein generally relates to near-eye displays, and particularly relates to optical modules and optical display apparatuses including the optical modules.

### BACKGROUND

Pancake lens blocks are widely used in near-eye display devices, such as head-mounted displays. A conventional pancake lens includes a stack structure of complex optical components with multiple optical surfaces, resulting that a near-eye display device using the conventional pancake lens is too thick and expensive, and is not conducive to mass production.

### BRIEF DESCRIPTION OF THE DRAWINGS

FIG. 1 shows a head-mounted display device according to an embodiment of the present application.

FIG. 2 shows an optical module according to an embodiment of the present application.

FIG. 3 shows an optical module according to a contrastive embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

“Above” means one layer is located on top of another layer. In one example, it means one layer is situated directly on top of another layer. In another example, it means one layer is situated over the second layer directly or indirectly with more layers or spacers in between.

When a feature or element is herein referred to as being “on” another feature or element, it can be directly on the other feature or element or intervening features and/or elements may also be present. It will also be understood that, when a feature or element is referred to as being “connected”, “attached” or “coupled” to another feature or element, it can be directly connected, attached, or coupled to the other feature or element or an intervening features or elements may be present.

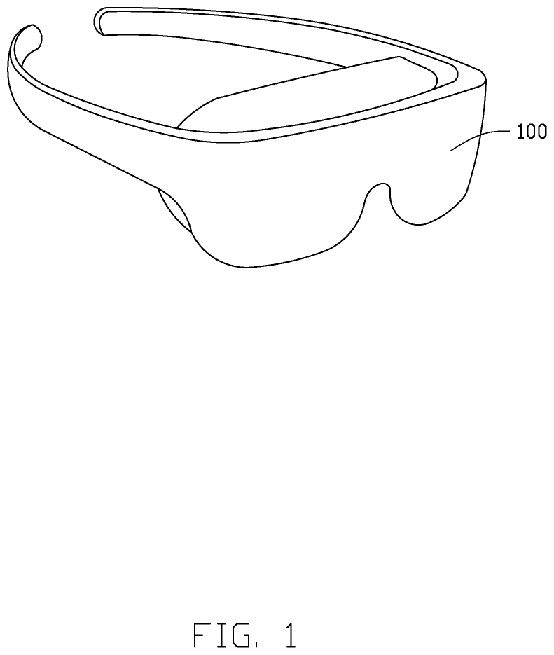

Referring to FIG. 1, a head-mounted display device 100 of the present application embodiment is used to display virtual reality images. Users can observe the virtual reality images by wearing the head-mounted display device 100 on their head. In at least one embodiment, the head-mounted display device 100 may be used in conjunction with a handle, a computer, etc.

In this embodiment, the head-mounted display 100 includes two sets of optical modules corresponding to a left eye and a right eye of human body. The two sets of optical modules have basically the same structure and function, and one of the two sets of optical modules will be explained as an example in the following.

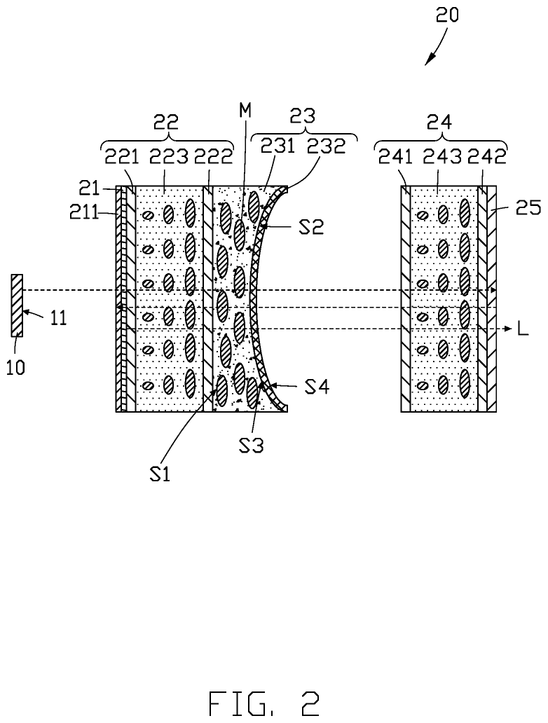

Referring to FIG. 2, the head-mounted display 100 includes a display screen 10 and an optical module 20. The display screen 10 has a display surface 11 facing the optical module 20. The display screen 10 is used to emit image light through the display surface 11. The optical module 20 is on an optical path of the image light and is used to modulate a polarization state, focus, beam size, and other parameters of the image light, and guide the image light after modulated to human eye to display an image.

The display screen 10 can be any type of display screen that can achieve image display, such as a liquid crystal display screen, organic light emitting diode display screen, miniature light emitting diode display screen, etc.

In this embodiment, the optical module 20 includes a quarter wave plate 21, a first polarization converter 22, a lens assembly 23, a second polarization converter 24, and a polarization reflection film 25 arranged in sequence. That is, in the optical module 20, the quarter wave plate 21 is closest to the display screen 10, and the polarization reflection film 25 is closest to human eye. In this embodiment, a surface of the quarter wave plate 21 near the display screen 10 is also coated with a semi-transparent and a semi-reflective film 211.

In this embodiment, the image light L is left-handed circularly polarized light. In other embodiments, the image light L can also be right-handed circularly polarized light, and the polarization state of the image light L is not limited.

In this embodiment, part of the image light L from the display screen 10 is transmitted by the semi-transparent and semi-reflective film 211, and the other part of the image light L from the display screen 10 is reflected by the semi-transparent and semi-reflective film 211. The part of the image light L transmitted by the semi-transparent and semi-reflective film 211 incidents onto the quarter wave plate 21 and is converted into horizontally polarized light by the quarter wave plate 21. The first polarization converter 22 is used to receive the image light L from the quarter wave plate 21. The lens assembly 23 is used to deflect and transmit the image light L from the first polarization converter 22. The second polarization converter 24 is used to receive the image light L from the lens assembly 23. The first polarization converter 22, the lens assembly 23, and the second polarization converter 24 do not change the polarization state of the image light L. The first polarization converter 22 and the second polarization converter 24 are used to jointly change the focus of the image light L.

The polarization reflection film 25 is configured to transmit image light in a target polarization state and to reflect image light in other polarization states besides the target polarization state. In this embodiment, the image light having the targe polarization state is vertically linearly polarized light. That is, in this embodiment, the polarization reflection film 25 is used to reflect horizontally polarized light and transmit vertically polarized light. Therefore, a horizontally polarized image light L is reflected by the polarized reflection film 25.

The image light L reflected by the polarization reflection film 24 sequentially passes through the second polarization converter 24, lens assembly 23, and first polarization converter 22, and then re-enters the quarter wave plate 21. The quarter wave plate 21 converts the image light L from the first polarization converter 22 from horizontally polarized light to vertically polarized light. The semi-transparent and semi-reflective film 211 reflects part of the image light L from the quarter wave plate 21 and transmits another part of the image light L from the quarter wave plate 21. The image light L reflected from the semi-transparent and semi-reflective film 211 passes through the first polarization converter 22, the lens assembly 23, the second polarization converter 24, and the polarization reflective film 25 in sequence. The polarized reflection film 25 is used to transmit the image light L since the image light L is vertically linearly polarized. The image light L transmitted from the polarized reflection film 25 is focused on the target position and received by the human eye to display the image to the users.

Therefore, the image light L from the display screen 10 passes through the optical module 20 for three times before being guided to the human eye, which extends the optical path of the image light L and is conducive to expand a field of view of the image light L. Due to volume limitation of the head-mounted display 100 itself, an area of the display surface 11 of the display screen 10 is also limited, which limits a beam size of the image light L emitted by the display surface 11. In this embodiment, the optical module 20 is used to fold the optical path of the image light L, which is beneficial for expanding the field of view of the image light L while reducing a volume of the head-mounted display 100.

In this embodiment, the first polarization converter 22 includes parallel and opposite first electrodes 221 and second electrodes 222, as well as a first liquid crystal layer 223 between the first electrode 221 and the second electrode 222. By applying first voltages to the first electrode 221 and the second electrode 222, a first electric field is formed between the first liquid crystal layer 223. Deflecting angles of liquid crystal molecules in the first liquid crystal layer 223 changes with the first electric field. By changing first voltages applied to the first electrode 221 and the second electrode 222, the first polarization converter 22 modulates a propagation direction of the image light L passing through the first liquid crystal layer 223, resulting in a change in the focusing position of the image light L.

The second polarization converter 24 includes a parallel and relatively arranged third electrode 241 and a fourth electrode 242, and the second polarization converter 24 also includes a second liquid crystal layer 243 between the third electrode 241 and the fourth electrode 242. By applying second voltages to the third electrode 241 and the fourth electrode 242, a second electric field is formed between the second liquid crystal layer 243. Deflecting angles of liquid crystal molecules in the second liquid crystal layer 243 changes with the second electric field. By changing the second voltages applied to the third electrode 241 and the fourth electrode 242, the second polarization converter 24 modulates a propagation direction of the image light L passing through the second liquid crystal layer 243, resulting in a change in the focusing position of the image light L.

By controlling the first voltages applied to the first electrode 221 and the second electrode 222 and the second voltages applied to the third electrode 241 and the fourth electrode 242 respectively, the image light L can be focused to the target position.

The lens assembly 23 is used to deflect (converge or diverge) the direction of the image light L, in order to change the propagation direction of the image light L, ultimately enabling the human eye to clearly observe the image. In this embodiment, the lens assembly 23 includes a liquid crystal lens 231 and a transparent substrate 232. The liquid crystal lens 231 has a flat surface S1 and a curved surface S2 opposite to each other, wherein the curved surface S2 protrudes towards the flat surface S1, making the liquid crystal lens 231 roughly equivalent to a concave lens. The transparent substrate 232 has two opposite surfaces S3 and S4. Shapes of the surfaces S3 and S4 are consistent with that of the curved surface S2. That is, shapes and convex directions of the surfaces S3 and S4 are the same as that of the curved surface S2. The transparent substrate 232 is on a side of the liquid crystal lens 231 having the curved surface S2. The surface S3 is closer to the liquid crystal lens 231 compared to the surface S4. The surface S3 sticks to the curved surface S2 of the liquid crystal lens 231. In this embodiment, the transparent substrate 232 is a glass substrate.

Due to the convex shape of the surfaces S3 and S4 of the transparent substrate 232 towards the liquid crystal lens 231, there is an air gap between the transparent substrate 232 and the second polarization converter 24. The image light L from the transparent substrate 232 enters the second polarization converter 24 through the air gap.

In a manufacturing process of the lens assembly 23, in order to make the liquid crystal lens 231 form the curved surface S2, it is necessary to use a rigid transparent substrate 232 to maintain the shape of the curved surface S2. The lens assembly 23 of this embodiment ultimately retains the transparent substrate 232. However, due to the consistent shape of the surfaces S3 and S4 of the transparent substrate 232 with the curved surface S2 of the liquid crystal lens 231, a total diopter of the lens assembly 23 equals a diopter of the liquid crystal lens 231. That is, the transparent substrate 232 does not affect the total diopter of the lens assembly 23. The diopter p of the liquid crystal lens 231 satisfies: p=1/f=(1−n)/R, wherein f is a focal length of the liquid crystal lens 231, n is a refractive index of the liquid crystal lens 231, and R is a curvature radius of the liquid crystal lens 231 (the curvature radius of the curved surface S2).

In a modified embodiment, the transparent substrate 232 can be removed after the liquid crystal lens 231 is formed. In the modified embodiment, since the transparent substrate 232 is not included in the final lens assembly 23, an opaque substrate can also be used in the process of form the curved surface S2 of the liquid crystal lens 321. In this embodiment, since the transparent substrate 232 is removed from the lens assembly 23, it is beneficial to further reduce a thickness of the lens assembly 23, thereby reducing a number of optical surfaces in the optical module 20 and improving an image display quality.

In this modified embodiment, due to the curved surface S2 of the liquid crystal lens 231 protruding towards the flat surface S1, there is also an air gap between the liquid crystal lens 231 and the second polarization converter 24. The image light L from the liquid crystal lens 231 enters the second polarization converter 24 through the air gap.

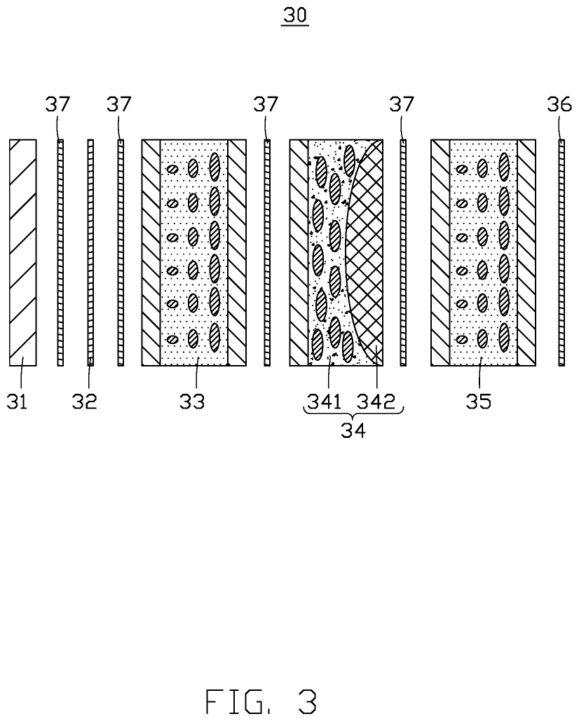

Referring to FIG. 3, in a contrastive embodiment, an optical module 30 includes a semi-transparent and semi-reflective substrate 31, a quarter wave plate 32, a first polarization converter 33, a lens assembly 34, a second polarization converter 35, and a polarization reflection film 36 arranged in sequence.

In the contrastive embodiment, the optical module 30 also includes multiple optical adhesive layers 37, each of which is between two adjacent optical elements (the semi-transparent and semi-reflective substrate 31, the quarter wave plate 32, the first polarization converter 33, the lens assembly 34, the second polarization converter 35, or the polarization reflection film 36) for bonding and fixing the two adjacent optical elements.

Referring to FIGS. 2 and 3, in the contrastive embodiment, the semi-transparent and semi-reflective substrate 31 and the quarter wave plate 32 are bonded and fixed through one of the optical adhesive layers 37. While in this embodiment of the present disclosure, the semi-transparent and semi-reflective film 211 is coating on the quarter wave plate 21, which replaces the semi-transparent and semi-reflective substrate 31 in the contrastive embodiment. By coating the quarter wave plate 21 with the semi-transparent and semi-reflective film 211, the optical adhesive layers 37 can be reduced in the optical module 20 of this embodiment. On the other hand, a total thickness of the optical module 20 can be reduced, and the number of optical surfaces in the optical module 20 can be reduced. Therefore, this embodiment of the present disclosure is beneficial for thinning the optical module 20 and improving image quality by coating the semi-transparent and semi-reflective film 211 on the quarter wave plate 21.

In the contrastive embodiment, the lens assembly 34 includes a liquid crystal lens 341 and a convex lens 342. An effect of the liquid crystal lens 341 on the image light Lis basically equivalent to a concave lens. A combination of the liquid crystal lens 341 and the flat convex lens 342 causes a total diopter of the lens assembly 34 equaling a difference of a diopter of the liquid crystal lens 341 and a diopter of the flat convex lens 342, which is not conducive to a deflection effect on the image light. While in this embodiment of the present disclosure, by replacing the flat convex lens 342 with the transparent substrate 232, the diopter of the liquid crystal lens 231 equals the total diopter of the lens assembly 23, which is beneficial for improving the total diopter of the lens assembly 23, enables the lens assembly 23 to achieve the same focusing amplitude with a smaller thickness compares to the lens assembly 34.

In the contrastive embodiment, the optical module 30 including multiple optical adhesive layers 37 increases the total thickness of the optical module 30. In this embodiment, the optical module 20 does not include any optical adhesive layer, and adjacent optical components (the quarter wave plate 21, the first polarization converter 22, the lens assembly 23, the second polarization converter 24, and the polarization reflection film 25) in the optical module 20 are fixed through mechanism manner. For example, the position relationship between optical elements can be maintained by opening a groove, providing a clamping mechanism, or creating a supporting state between adjacent optical elements.

In this embodiment, fixing and maintaining the position of the optical components by the mechanism manner is beneficial for reducing the number of optical surfaces in the optical module 20, making the optical module 20 thinner and lighter, and reducing the cost of the optical module 20.

In other embodiments of the present disclosure, the optical module 20 can also be applied to other optical display apparatuses, such as in automotive head-up display devices or 3C lenses.

The optical module 20 of this embodiment includes the lens assembly 23 including the liquid crystal lens 231 with the flat surface S1 and the curved surface S2. The effect of the liquid crystal lens 231 on the image light L is basically equivalent to a concave lens. The image light L from the liquid crystal lens 231 in this embodiment is directly incident into the subsequent optical path. Comparing to the lens assembly 34 in FIG. 3, the lens assembly 23 does not include other lenses, so the lens assembly 23 has a small thickness. And since the lens assembly 23 does not include other lenses, the total diopter of the lens assembly 23 will not be reduced by other lenses and equals to the diopter of the liquid crystal lens 231. Therefore, the lens assembly 23 is able to have a smaller thickness than the lens assembly 34 when achieving a same focusing amplitude.

Furthermore, in this embodiment, the adjacent optical elements in the optical module 20 are fixed by mechanism manner, which can reduce the optical adhesive layers and reduce the number of optical surfaces in the optical module 20 and is beneficial for reducing the thickness of the optical module 20 and improving the image display quality.

Moreover, in this embodiment, a separate semi-transparent and semi-reflective film is reduced in the optical module 20 by coating the quarter wave plate 21, which is conducive to further reducing the optical adhesive layer and reducing the number of optical surfaces in the optical module 20. On the one hand, it is beneficial to reduce the thickness of the optical module, and on the other hand, it is beneficial to improve the image display quality.

Finally, it should be noted that the above embodiments are only used to illustrate the technical solution of the present application and not to limit the present application. Although the present application has been described in detail with reference to preferred embodiments, one ordinary skill in the art should understand that the technical solution of the present application can be modified or equivalent replaced without departing from the spirit and scope of the technical solution of the present application.

What is claimed is:

1. An optical module comprising:
a quarter wave plate for receiving image light and converting a polarization state of the image light;
a first polarization converter and a second polarization converter both for receiving the image light from the quarter-wave plate and focusing the image light to a target position;
a lens assembly between the first polarization converter and the second polarization converter, the lens assembly comprising a liquid crystal lens with a flat surface and a curved surface opposite the flat surface, the flat surface being closer to the quarter wave plate than the curved surface, the curved surface protruding towards the quarter wave plate, the image light from the curved surface transmitting to the second polarization converter through an air gap; and
a polarization reflection film for receiving the image light from the second polarization converter, the polarization reflection film being configured to transmit the image light having a target polarization state, and make the image light transmitted through converge at the target position to display an image.

2. The optical module according to claim 1, wherein the lens assembly further comprises a transparent substrate between the liquid crystal lens and the second polarization converter, and
the transparent substrate comprises two surfaces opposite to each other, shapes of the two surfaces consistent with the curved surface of the liquid crystal lens, so that one of the two surfaces sticks to the curved surface of the liquid crystal lens, and the air gap exists between the transparent substrate and the second polarization converter, and the image light from the curved surface transmits to the second polarization converter through the transparent substrate and the air gap.

3. The optical module according to claim 2, wherein the transparent substrate is a glass substrate.

4. The optical module according to claim 1, wherein a diopter of the lens assembly is the same as a diopter of the liquid crystal lens.

5. The optical module according to claim 1, wherein a surface of the quarter wave plate away from the lens assembly is coated with a semi-transparent and semi-reflective film, the semi-transparent and semi-reflective film is configured for transmitting a part of the image light to the quarter wave plate.

6. The optical module according to claim 1, wherein the quarter wave plate, the first polarization converter, the lens assembly, the second polarization converter, and the polarization reflection film are fixed by a mechanism manner to maintain positional relationships.

7. The optical module according to claim 1, wherein an air gap is between the lens assembly and the second polarization converter.

8. The optical module according to claim 1, wherein the first polarization converter comprises a first electrode, a second electrode, and a first liquid crystal layer between the first electrode and the second electrode, a first electric field is generated when first voltages are applied to the first electrode and the second electrode, and liquid crystal molecules in the first liquid crystal layer are deflected according to the first electric field,
the second polarization converter comprises a third electrode, a fourth electrode, and a second liquid crystal layer between the third electrode and the fourth electrode, a second electric field is generated when second voltages are applied to the third electrode and the fourth electrode, and liquid crystal molecules in the second liquid crystal layer are deflected according to the second electric field; and
the first polarization converter and the second first polarization converter are configured to control a propagation direction of the image light by controlling the first voltages and the second voltages.

9. An optical display apparatus comprising:
a display screen for emitting image light; and
an optical module comprising:
a quarter wave plate for receiving the image light and converting a polarization state of the image light;
a first polarization converter and a second polarization converter for receiving the image light from the quarter-wave plate and focusing the image light to a target position;
a lens assembly between the first polarization converter and the second polarization converter, the lens assembly comprising a liquid crystal lens with a flat surface and a curved surface opposite the flat surface, the flat surface being closer to the quarter wave plate than the curved surface, the curved surface protruding towards the quarter wave plate, the image light from the curved surface transmitting to the second polarization converter through an air gap; and
a polarization reflection film for receiving the image light from the second polarization converter, the polarization reflection film being configured to transmit the image light having a target polarization state, and make the image light transmitted through converge at the target position to display an image.

10. The optical display apparatus according to claim 9, wherein the lens assembly further comprises a transparent substrate between the liquid crystal lens and the second polarization converter, and
the transparent substrate comprises two surfaces opposite to each other, shapes of the two surfaces consistent with the curved surface of the liquid crystal lens, so that one of the two surfaces sticks to the curved surface of the liquid crystal lens, and the air gap exists between the transparent substrate and the second polarization converter, and the image light from the curved surface transmits to the second polarization converter through the transparent substrate and the air gap.

11. The optical display apparatus according to claim 10, wherein the transparent substrate is a glass substrate.

12. The optical display apparatus according to claim 9, wherein a diopter of the lens assembly is the same as a diopter of the liquid crystal lens.

13. The optical display apparatus according to claim 9, wherein a surface of the quarter wave plate away from the lens assembly is coated with a semi-transparent and semi-reflective film, the semi-transparent and semi-reflective film is configured for transmitting a part of the image light to the quarter wave plate.

14. The optical display apparatus according to claim 9, wherein the quarter wave plate, the first polarization converter, the lens assembly, the second polarization converter, and the polarization reflection film are fixed by a mechanism manner to maintain positional relationships.

15. The optical display apparatus according to claim 9, wherein an air gap is between the lens assembly and the second polarization converter.

16. The optical display apparatus according to claim 9, wherein the first polarization converter comprises a first electrode, a second electrode, and a first liquid crystal layer between the first electrode and the second electrode, a first electric field is generated when first voltages are applied to the first electrode and the second electrode, and liquid crystal molecules in the first liquid crystal layer are deflected according to the first electric field;
the second polarization converter comprises a third electrode, a fourth electrode, and a second liquid crystal layer between the third electrode and the fourth electrode, a second electric field is generated when second voltages are applied to the third electrode and the fourth electrode, and liquid crystal molecules in the second liquid crystal layer are deflected according to the second electric field; and
the first polarization converter and the second first polarization converter are configured to control a propagation direction of the image light by controlling the first voltages and the second voltages.

17. The optical display apparatus according to claim 9, wherein the optical display apparatus is a head-mounted display device or a head-up display device.
